(19) United States
(12) Patent Application Publication
(10) Pub. No.: US 2010/0258547 A1
(43) Pub. Date: Oct. 14, 2010

(54) ELECTRICALLY HEATABLE LAMINATED GLAZING

(75) Inventors: Mark Andrew Chamberlain, Merseyside (GB); Jonathan Barclay Dixon, Lancashire (GB)

Correspondence Address: BUCHANAN, INGERSOLL & ROONEY PC, POST OFFICE BOX 1404, ALEXANDRIA, VA, 22313-1404, US

(73) Assignee: Pilkington Group LImited, Merseyside (GB)

(21) Appl. No.: 12/808,840

(22) PCT Filed: Jan. 9, 2009
(86) PCT No.: PCT/GB09/50011

§ 371 Date: Jun. 17, 2010

(30) Foreign Application Priority Data
Jan. 11, 2008 (GB) 0800448.3

(51) Int. Cl. B60L 1/02

(52) U.S. Cl. 219/203

(57) ABSTRACT

The invention discloses an electrically heated window having minimised hot spots. The window comprises at least two plies of a glazing material having a ply of an interlayer material laminated therebetween. An array of heating wires is carried by one of the plies, the heating wires extending between a first electrical connection means and a second electrical connection means for supplying current through the wires, the first and second electrical connection means being substantially parallel to each other. The first electrical connection means is shaped so as to define a wire-free area to allow a data signal to be transmitted through the window to a device positioned in the vicinity of the wire-free area. The second electrical connection means is shaped to correspond to the first electrical connection means, such that the heating wires in the array have a substantially constant length.

The present invention relates to an electrically heated window, in particular, a laminated electrically heated window comprising an array of heating wires (a wire-heated window).

Electrically heated windows are commonly used as either windscreens or backlights in vehicles in order to be able to demist or defrost the window in cold and/or damp weather conditions. For windows used as a windscreen in a vehicle, the electrical heating means are generally provided as an array of fine (having a diameter of less than 150 μm), closely spaced (a wire-to-wire distance of between 1 mm and 5 mm) wires. Although the wires in the array are essentially parallel, each is provided with undulations, such as crimping in a sinusoidal, helical, zig zag or random pattern, to avoid dazzling and polarisation effects when objects are viewed through the window by a vehicle driver.

It is increasingly desirable to be able to transmit data signals to and from devices positioned in or on the inside of window in a vehicle. For example, antennas, amplifiers, GPS (global positioning systems) and toll collection systems all require data signals that are electromagnetic in nature, and which may be degraded if transmitted through a window containing a heating wire array. One solution to this problem is to provide a wire-free area within the window, through which such signals can be transmitted without any interference from the surrounding wires, and with no detrimental effect on the heating performance of the array. Such a solution is adopted in EP 1 672 960 A1, which discloses a wire-free area formed either by deviating the bus bar used to connect the wires to a power supply, or by locally removing a number of wires. In the latter case, the area is provided with additional electrical connections to wires in the region of the wire-free area to ensure the continued functionality of the heated window. Similar solutions have been adopted for windows comprising an electrically conductive coating to provide a heating function, by removing a portion of the coating to enable data transmission, as described in U.S. Pat. No. 6,670,581.

Whilst such solutions are satisfactory inasmuch as they allow both data transmission and heating function within the same window, when using a wire array, local variation in the power density achieved occurs due to differences between the resistances of those wires adjacent the wire-free area and those a distance away from the wire-free area. This creates regions of non-constant temperature, known as hot spots. The presence of one or more hot spots in a window is highly undesirable for two reasons: firstly, there is a risk that the occupants of a vehicle in which such a window is fitted may touch the window in the region of the one or more hotspots, causing injury; and secondly, there is a risk of the window locally de-laminating in the region of the hot spots. This results in regions of the window having reduced or zero visibility.

Consequently, it is desirable to produce a wire-heated window, having a wire-free area for data transmission, in which the problems of hot spots are minimised or removed completely.

The present invention aims to address these problems by providing an electrically heated window, comprising: at least two plies of a glazing material having a ply of an interlayer material laminated therebetween; and an array of heating wires carried by one of the plies, the heating wires extending between a first electrical connection means and a second electrical connection means for supplying current through the wires, the first and second electrical connection means being substantially parallel to each other; the first electrical connection means being shaped so as to define a wire-free area to allow a data signal to be transmitted through the window to a device positioned in the vicinity of the wire-free area; wherein the second electrical connection means is shaped to correspond to the first electrical connection means, such that the heating wires in the array have a substantially constant length.

By ensuring that the wires within the heating wire array have a substantially constant length, it is possible to minimise the occurrence of hot spots as by preventing the array having a variable resistance, the power density across the window, when current is passed through the wires, will be uniform.

Preferably, the wire-free area is adjacent an edge of the window. Preferably, the wire-free area is concealed by an obscuration band positioned around the periphery of the window.

Preferably, the first and second electrical connection means are concealed by an obscuration band positioned around the periphery of the window.

Preferably, the array of wires is embedded in the layer of interlayer material. Preferably, the electrical connection means are in contact with the ply of interlayer material. The electrical connection means may be formed from a thin metal foil.

The spacing between the wires in the array is preferably in the range 1.9 mm to 2.5 mm.

Preferably the device is one of a sensor, and antenna, an amplifier, a signal receiving device or a signal transmitting device.

The present invention will now be described by way of example only, and with reference to the accompanying drawings, in which:

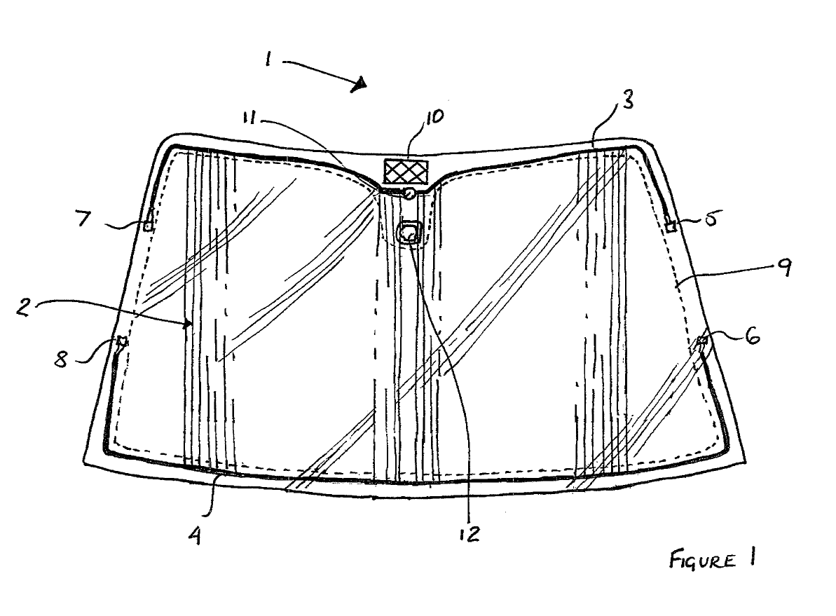

FIG. 1 is a schematic plan view of a wire-heated window having a wire-free area in accordance with the prior art;

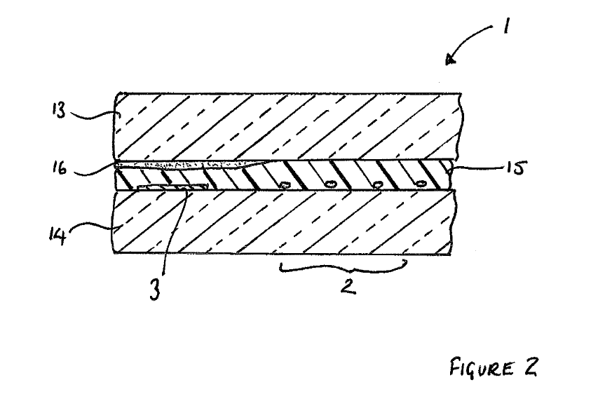

FIG. 2 is a schematic cross-section of a side edge region of the wire-heated window shown in FIG. 1;

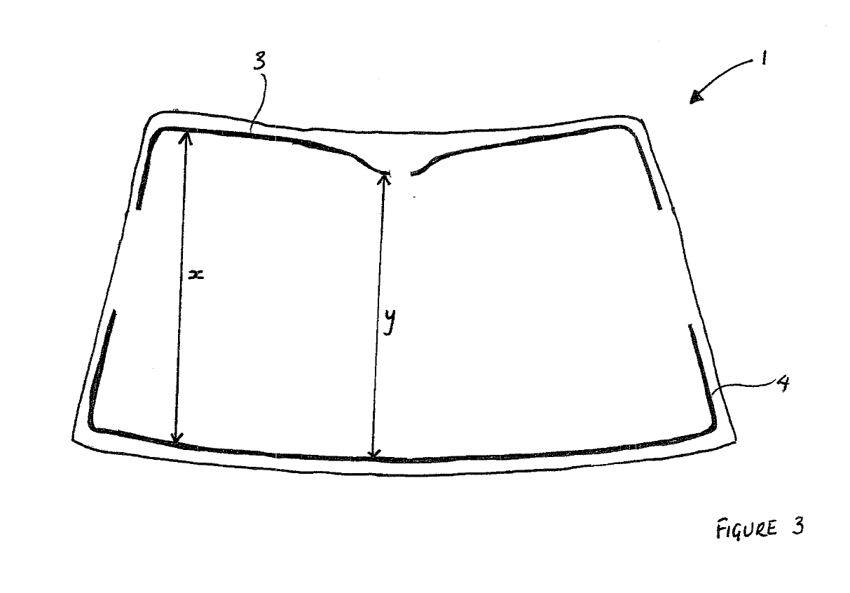

FIG. 3 is a schematic plan view of the window in FIG. 1, showing bus bar separations;

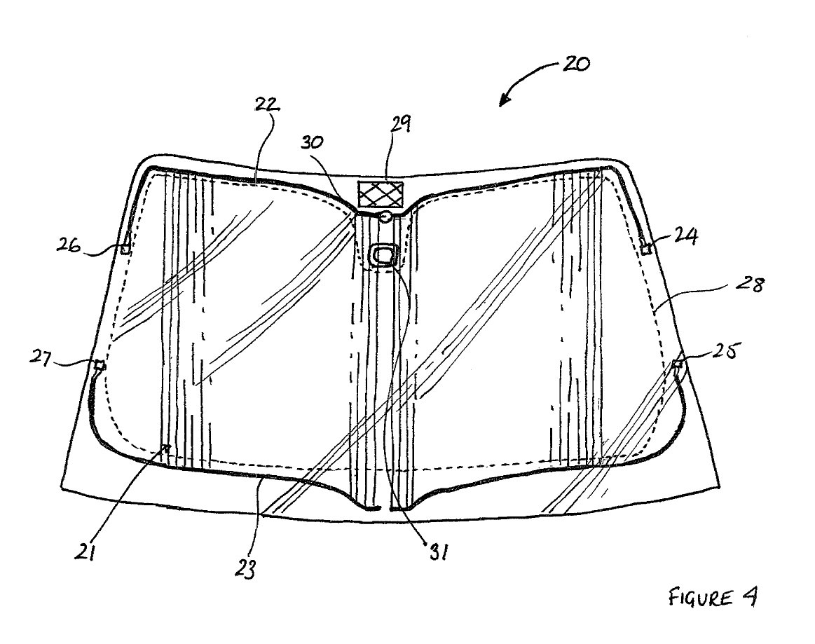

FIG. 4 is a schematic plan view of a wire-heated window having a wire-free area in accordance with an embodiment of the present invention; and

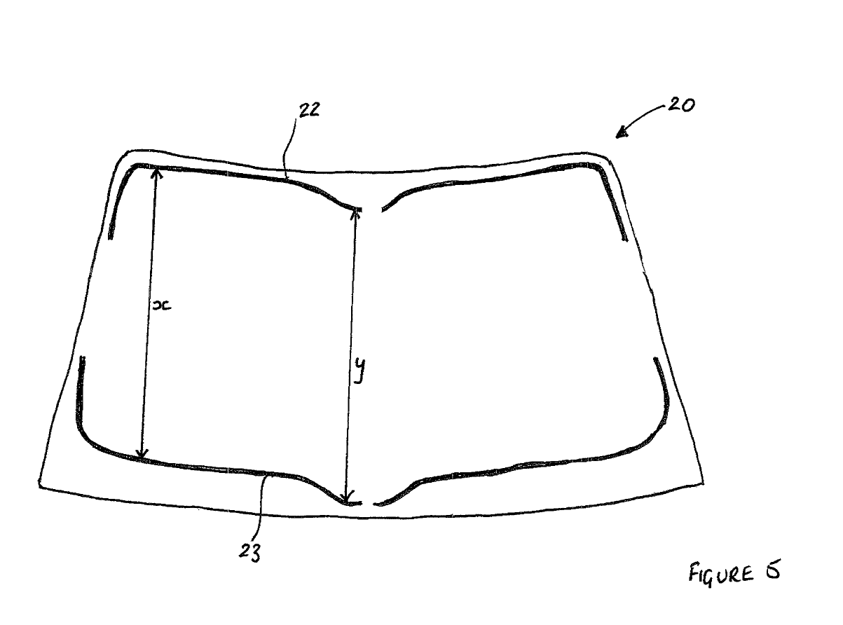

FIG. 5 is a schematic plan view of the window in FIG. 4, showing bus bar separations.

In order to minimise variation in power density across a wire-heated window, the present invention provides electrical connection means (bus bars) having corresponding shapes, such that the lengths of the wires in an array extending between the electrical connection means remains substantially constant.

This concept is best illustrated by first considering a wire-heated windscreen common in the prior art. FIG. 1 is a schematic plan view of a wire-heated window having a wire-free area in accordance with the prior art. The wire-heated window 1 is generally trapezoidal in shape, and comprises an array of fine, closely-spaced wires 2, of which only a small proportion are shown for clarity. The array of wires 2 is bounded by a first electrical connection means or bus bar 3 and a second electrical connection means or bus bar 4. The wires within the array 2 extend between the first and second electrical connection means 3, 4. These electrical connection means 3, 4 connect the array to an electrical supply (not shown) by means of connectors 5, 6, 7, 8, which may be plug connectors or other connectors known within the art. A dotted line 9 represents the extent to which the periphery of the window is covered by an obscuration band. An obscuration band is usually provided by a printed, fired black ceramic ink positioned on an inner surface of the window. The function of the obscuration band is two-fold: firstly, aesthetic, as it acts to hide the edge of the window and cover the adhesive used to bond the window into a vehicle, as well as the frame surrounding the window aperture; and secondly, it prevents degradation of the adhesive used to bond the window into the vehicle due to exposure to UV rays in sunlight.

The wire-free area 10 is represented by a hatched region, and in this example, is positioned adjacent the top edge of the window 1 (when fitted into a vehicle). A bus bar 3 is shaped to as to define the wire-free area to allow a data signal to be transmitted through the window to a device positioned in the vicinity of the wire-free area. Ideally, the wire-free area 10 is concealed by the obscuration band. In addition, the window 1 is provided with an area 11 for affixing a mirror boss, and an area 12 for affixing a sensor, such as a light or moisture sensor.

FIG. 2 is a schematic cross-section of a side edge region of the wire heated window shown in FIG. 1. The window 1 comprises first 13 and second 14 plies of annealed silicate float glass having a ply of polyvinyl butyral interlayer material 15 extending and laminated therebetween. The obscuration band 16 is provided around the periphery of the window 1, obscuring one of the bus bars 3. At the side of the window 1, the wires in the array 2 are parallel with the edge of the window 1.

FIG. 3 is a schematic plan view of the window in FIG. 1, showing bus bar separations. In this Figure, only the bus bars 3, 4 and the general shape of the window are shown for clarity. The bus bar 3 running along the top edge of the window 1, adjacent the wire-free region 10 is shaped to define the wire-free region, with several turns or corners. In this example, the bus bar 3 running along the top edge of the window 1 is in two portions, separated by a small break positioned on a line of approximate mirror symmetry vertically in the centre of the window 1.

The spacing between the bus bar 3 running along the top edge of the window 1 and the bus bar 4 running along the bottom edge of the window in an edge region of the window 1 (which would be adjacent the “A” pillar when fitted in a vehicle) is represented by distance x. The spacing between the bus bar 3 running along the top edge of the window 1 and the bus bar 4 running along the bottom edge of the window in the centre, adjacent the wire-free area 10 is represented by spacing y. Typically, the spacing y at the centre of the window 1 is 10% larger than the spacing x at the edge of the window 1 adjacent the “A” pillar. This leads to a region having the same width as the wire-free area having an increased temperature in comparison with the remainder of the window due to the decrease in resistance and consequential increase in current carried in the shorter wires. As the wire-free area may be up to 300 mm in width, this hot spot region may also be at least 300 mm in width. The difference in power density is marked, as shown in Table 1:

TABLE 1
comparison of individual wire properties

| | | |
|---|---|---|
| Wire Length (mm) | 900 | 800 |
| Wire Diameter (μm) | 140 | 140 |
| Crimp | 7 | 7 |
| Wire Resistance (Ω) | 135 | 120 |
| Voltage (V) | 13 | 13 |
| Wire Spacing (mm) | 2.09 | 2.09 |
| Power Density (W/m²) | 600 | 675 |

where the crimp of the wire is expressed as 100×(uncrimped length−crimped length)/crimped length.

To overcome this problem, and without requiring the wire spacing to be varied across the width of the window, the present invention provides for both electrical connection means (bus bars) to have corresponding shapes, such that each is deviated by the same or a similar amount to ensure that the wires in the array have lengths that are substantially constant. This prevents variation in the resistance of adjacent wires, minimising the occurrence of hot spots.

FIG. 4 is a schematic plan view of a wire-heated window having a wire-free area in accordance with an embodiment of the present invention. The wire-heated window 20 is generally trapezoidal in shape (having two opposing long edges and two opposing shorter edges), and comprises an array of fine, closely-spaced wires 21, of which only a small proportion are shown for clarity. The array of wires 21 is bounded by a first electrical connection means or bus bar 22 and a second electrical connection means or bus bar 23. The first 22 and second 23 electrical connection means are substantially parallel with each other. The wires within the array 21 extend between the first and second electrical connection means 22, 23. These electrical connection means 22, 23 connect the array to an electrical supply (not shown) by means of connectors 24, 25, 26, 27, which may be plug connectors or other connectors known within the art. A dotted line 28 represents the extent to which the periphery of the window is covered by an obscuration band. An obscuration band is usually provided by a printed, fired black ceramic ink positioned on an inner surface of the window. The wire-free area 29 is represented by a hatched region, and in this example, is positioned adjacent the top edge of the window 20 (when fitted into a vehicle). A bus bar 22 is shaped to as to define the wire-free area to allow a data signal to be transmitted through the window to a device positioned in the vicinity of the wire-free area. Ideally, the wire-free area 29 is concealed by the obscuration band. In addition, the window 1 is provided with an area 30 for affixing a mirror boss, and an area 31 for affixing a sensor, such as a light or moisture sensor.

The bus bar 22 running along the top edge of the window 20, adjacent the wire-free region 29 is shaped to define the wire-free region, with several turns or corners. The bus bar 23 running along the bottom edge of the window 20 has a corresponding shape, with the same number of turns or corners and dimensions, such that the length of each wire in the array 21 is substantially constant. Consequently, variations in power density and therefore hot spots are minimised. Preferably, both of the bus bars 22, 23 are concealed by the obscuration band. This is shown diagrammatically in FIG. 5.

FIG. 5 is a schematic plan view of the window in FIG. 1, showing bus bar separations. In this Figure, only the bus bars 22, 23 and the general shape of the window 20 are shown for clarity. The spacing between the bus bar 22 running along the top edge of the window 20 and the bus bar 23 running along the bottom edge of the window in an edge region of the window 20 (which would be adjacent the “A” pillar when fitted in a vehicle) is represented by distance x. The spacing between the bus bar 22 running along the top edge of the window 20 and the bus bar 23 running along the bottom edge of the window in the centre, adjacent the wire-free area 29 is represented by spacing y. In this embodiment of the invention, the distances x and y are approximately equal.

For good defrosting performance, it is generally desirable to ensure a uniform power density of 600 W/m² across the entire window. In the above design, this may be achieved by using a tungsten wire having a diameter between 20 and 25 μm and a spacing between 1.9 and 2.5 mm. Preferably, the bus bars are formed from a thin metal foil, such as a tinned copper strip, 3 to 6 mm in width and 0.03 to 0.08 mm thick, with the tinned surface comprising either elemental Sn or an alloy having a Sn:Pb ratio of 60:40. The bus bars may be a single piece of foil, or may be formed of two pieces of foil, superimposed with the wires of the array sandwiched in between. Typically the ply of interlayer material is 0.76 mm in thickness, and the plies of glass in the range 1.2 to 3.0 mm in thickness. Although the invention is described in terms of annealed silicate float glass, other types of glass or glazing materials, such as polycarbonate or plastics may be used in place of such glass plies. The wires in the array are preferably embedded within a surface of the ply of interlayer material, using a method such as that described in EP 0 443 691. Preferably the wires are crimped to minimise optical effects.

Desirably, the wire-free area is used to transmit signals to one of a sensor, and antenna, an amplifier, a signal receiving device (such as a global positioning system) or a signal transmitting device (such as a toll payment device).

1. An electrically heated window, comprising:
at least two plies of a glazing material having a ply of an interlayer material laminated therebetween; and
an array of heating wires carried by one of the plies, the heating wires extending between a first electrical connection means and a second electrical connection means for supplying current through the wires, the first and second electrical connection means being substantially parallel to each other;
the first electrical connection means being shaped so as to define a wire-free area to allow a data signal to be transmitted through the window to a device positioned in the vicinity of the wire-free area;
wherein the second electrical connection means is shaped to correspond to the first electrical connection means, such that the heating wires in the array have a substantially constant length.

2. The electrically heated window of claim 1, wherein the wire-free area is adjacent an edge of the window.

3. The electrically heated window of claim 1, wherein the wire-free area is concealed by an obscuration band positioned around the periphery of the window.

4. The electrically heated window of claim 1, wherein the first and second electrical connection means are concealed by an obscuration band positioned around the periphery of the window.

5. The electrically heated window of claim 1, wherein the array of wires is embedded in the layer of interlayer material.

6. The electrically heated window of claim 5, wherein the electrical connection means are in contact with the ply of interlayer material.

7. The electrically heated window of claim 1, wherein the electrical connection means are formed from a thin metal foil.

8. The electrically heated window of claim 1, wherein the spacing between the wires in the array is in the range 1.9 mm to 2.5 mm.

9. The electrically heated window of claim 1, wherein the device is one of a sensor, and antenna, an amplifier, a signal receiving device or a signal transmitting device.
